(19) United States
(12) Patent Application Publication
(10) Pub. No.: US 2003/0126087 A1
(43) Pub. Date: Jul. 3, 2003

(54) Method for supplying information, system for supplying information, recorder/reproducer, and recording medium

(76) Inventors: Tomio Kakiuchi, Saijo-shi (JP); Masayuki Takahashi, Toyo-shi (JP); Hitoshi Kawamukai, Onsen-gun Ehime (JP); Takami Uemura, Niihama-shi (JP); Kohei Kubo, Saijo-shi (JP); Toshinori Ito, Saijo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/182,268

(22) PCT Filed: Nov. 27, 2001
(86) PCT No.: PCT/JP01/10311

(30) Foreign Application Priority Data
Nov. 27, 2000 (JP) 2000358667

(51) Int. Cl. G06F 17/60

(52) U.S. Cl. 705/51

(57) ABSTRACT

As shown in FIG. 1, in an information supply system according to the present invention, a user available area in a built-in recording medium (20) of a recording/reproduction device (10) is used as a contents storage area, so that contents (23a) which can be used by a user are previously recorded in the built-in recording medium (20) when the recording/reproduction device (10) is shipped.

Therefore, in the information supply system which enables the user to use the contents stored in the recording medium, from/on which the contents can be read and rewritten via the recording/reproduction device, the activity ratio of the recording medium at shipment is increased and, thus, an opportunity of contents distribution can be increased.

### TECHNICAL FIELD

The present invention relates to an information supply method and an information supply system for supplying users with contents stored in a recording medium from/on which contents can be read and rewritten via a recording/reproduction device, the recording/reproduction device, and the recording medium.

### BACKGROUND ART

In recent years, in computer systems for controlling and managing office automation equipment or industrial equipment, storage devices that store information data have come to be required to have a high capacity with an increase in the amount of the information data dealt therein. Nowadays, as a high-capacity storage device satisfying such requirement, a magnetic disk device which employs a magnetic disk as a recording medium is widely used.

Further, with a recent price-reduction of the computer systems, prices of the magnetic disk devices are also greatly reduced. The prices and capacity of the magnetic disk devices reach the level applicable to consumer equipment, and a recording/reproduction device which employs the magnetic disk device as a recording medium for recording/reproducing video data or the like is being introduced as an applied consumer product.

In an information supply method in which a user accesses contents on the recording medium via this recording/reproduction device, tens and more of GBs of capacity is secured for the recording medium of the recording/reproduction device so that a large quantity of video data can be recorded/reproduced. When the recording/reproduction device as described above is shipped, only information that is minimally required to start the recording/reproduction device is previously recorded on the recording medium, and most of the area in the recording medium corresponding to tens and more of GBs is allocated as a user available area so that a user can record/reproduce contents therein/therefrom after purchasing the recording/reproduction device.

Hereinafter, the conventional information supply method as described above will be schematically described. FIG. 17 is a diagram illustrating a state of the recording medium which is used in the recording/reproduction device, at shipment.

With reference to FIG. 17, a recording/reproduction device 10 for recording/reproducing video data includes a recording medium 20 as a medium in which the video data are recorded. The recording medium 20 is divided into a system using area 21 and a user available area 22 which constitutes a major portion of the recording medium 20. The system using area 21 contains information used by the recording/reproduction device 10 to start the same. The user available area 22 contains no effective information at the shipment, and is secured so that a user records/reproduces the video data therein/therefrom after purchasing the recording/reproduction device 10.

However, in the conventional information supply method as described above, the recording medium 20 is shipped with an area where useful contents can be stored left merely as a free space for the user available area 22. Reading/rewriting from/on the recording medium 20 can be performed via the recording/reproduction device 10, and the contents on the recording medium 20 are not deteriorated even when one more rewiring of the contents onto the recording medium 20 is performed by a user.

In other words, in the conventional information supply method, regardless of good environment for providing and distributing useful contents via the recording medium 20 at the shipment, this opportunity is not fully used.

The present invention is made to solve the above-described problem and has for its object to provide an information supply method, an information supply system, a recording/reproduction device, and a recording medium, which enable to give more opportunities of contents distribution without constructing new contents distribution channels for supplying contents.

### DISCLOSURE OF THE INVENTION

According to claim 1 of the present invention, there is provided an information supply method for storing contents in a recording medium from/on which the contents can be read and rewritten via a recording/reproduction device, and supplying a user with the stored contents, in which a user available area as a free space other than a system using area where data required for starting a system of the recording/reproduction device is stored in a recording medium of the recording/reproduction device is used as a contents storage area, and the recording/reproduction device in which the contents that can be used by the user are previously recorded in the contents storage area is shipped and supplied to the user, so that the user is supplied with the contents.

Therefore, the activity ratio of the recording medium at the shipment of the recording/reproduction device is increased, and contents can be provided to a user without constructing new contents distribution channels for the supply of contents, resulting in more opportunities for contents distribution.

According to claim 2 or the present invention, there is provided an information supply system for storing contents in a recording medium from/on which the contents can be read and rewritten via a recording/reproduction device, and supplying a user with the stored contents, in which the recording/reproduction device has the recording medium that includes a system using area for storing data required to start a system of the recording/reproduction device, and a contents storage area in which the contents that can be used by the user are previously recorded, which is a user available area as a free space other than the system using area, and the recording/reproduction device is shipped and provided to the user.

Therefore, it is possible to supply a user with contents without constructing new contents distribution channels for the supply of contents.

According to claim 3 of the present invention, there is provided a recording medium of a recording/reproduction device in an information supply method for storing contents in a recording medium from/on which the contents can be read and rewritten via a recording/reproduction device, and supplying a user with the stored contents comprising: a system using area containing data required to start a system of the recording/reproduction device, and a contents storage area containing the contents which can be used by the user, when the recording medium of the recording/reproduction device is shipped.

Therefore, the activity ratio of the recording medium at the shipment of the recording/reproduction device can be increased.

According to claim 4 of the present invention, in the information supply method as defined in claim 1, the contents are supplied to the user under control of a contents management center which is connected with the recording/reproduction device via a communication line, the contents which can be used by the user, and contents attribute information indicating whether the contents are charged or free are previously recorded in the contents storage area of the recording medium, and in the recording/reproduction device, every time the user requests an access to contents stored in the contents storage area, the contents attribute information of the contents is referred to, a condition of an access to the contents is set according to control information from the contents management center on the basis of the contents attribute information of the access-requested contents, and when the access-requested contents are registered as being charged, the access condition is set so that the access-requested contents are to be purchased, pay contents purchase information of the access-requested pay contents is registered with the contents management center and the contents attribute information in the contents storage area after purchase of the access-requested pay contents is decided, and the access-requested pay contents are supplied to the user, while when the access-requested contents are registered as being free, the access condition is set as “no-condition” and the access-requested free contents are supplied to the user.

Therefore, pay/free contents can be provided to a user without constructing new contents distribution channels for the supply of contents, resulting in more opportunities for contents distribution.

According to claim 5 of the present invention, the information supply system as defined in claim 2 comprises the recording/reproduction device that is supplied to the user with the contents that can be used by the user and contents attribute information indicating whether the contents are charged or free, previously recorded in the contents storage area of the recording medium, and a contents management center which is connected with the recording/reproduction device via a communication line and manages the contents stored in the contents storage area of the recording medium, the recording/reproduction device includes: a contents attribute information reference means for referring to the contents attribute information every time the user requests an access to the contents stored in the contents storage area; and an access condition setting means for setting a condition of access to the contents which is requested to be accessed by the user according to control information from the contents management center on the basis of the result of the contents attribute information reference means, and the contents management center comprises: a contents purchase information registration means for registering pay contents purchase information of the access-requested pay contents with the contents management center and the contents attribute information in the contents storage area, when the access-requested contents are registered as being charged; and an access permission means for permitting the user to access the access-requested pay contents on the basis of the pay contents purchase information.

Therefore, pay/free contents which are mixedly stored in the recording medium of the recording/reproduction device can be supplied to a user without constructing new contents distribution channels for the supply of contents.

According to claim 6 of the present invention, in the recording medium as defined claim 3, the contents which can be used by the user, and contents attribute information indicating whether the contents are charged or free are previously recorded in the contents storage area.

Therefore, the activity ratio of the recording medium at the shipment of the recording/reproduction device can be increased, and pay/free contents can be mixedly stored in the recording medium.

According to claim 7 of the present invention, the recording/reproduction device connected to the contents management center in the information supply system as defined in claim 5, comprises: a contents attribute information reference means for referring to the contents attribute information indicating whether the contents stored in the recording medium are charged or free, every time the user requests access to the contents stored in the recording medium of the recording/reproduction device; an access condition setting means for setting a condition of an access to the contents which is requested to be accessed, on the basis of the result of the contents attribute information reference means; a contents access control means for controlling a user access to the contents on the basis of the access condition; a transmission/reception means which is connected to the contents management center via the communication line to transmit/receive data and the control information; and a control means for controlling the operation of the recording/reproduction device according to the control information from the contents management center.

Therefore, it is possible to provide a recording/reproduction device which enables to supply a user with desired contents among pay/free contents that are mixedly stored in the recording medium at shipment.

According to claim 8 of the present invention, in the information supply method as defined in claim 4, in a case where the access-requested contents are registered as being charged, the access condition is set so that the access-requested pay contents are to be purchased; when the user makes a purchase contents selection request to the contents management center, a list of pay contents and price information thereof, which are previously stored in the contents storage area are transmitted from the contents management center; when the user selects contents to purchase from the list of pay contents, pay contents purchase information of the pay contents decided to be purchased is registered with the contents management center and the contents attribute information in the contents storage area after purchase of the pay contents is decided, and the pay contents are supplied to the user; when the user specifies whether unpurchased contents other than the contents which is decided to be purchased are deleted from the contents storage area or not, information of the contents specified to be deleted is registered with the contents management center and the contents attribute information in the contents storage area as contents deletion information, and an area occupied by the unpurchased contents specified to be deleted is processed as a user available area where no contents exists, on the basis of the contents deletion information.

Therefore, pay/free contents can be supplied to a user without constructing new contents distribution channels for the supply of contents. Further, it is possible to recognize user trends of pay contents purchase.

According to claim 9 of the present invention, in the information supply system as defined in claim 5, the contents management center comprises: a purchase contents selection means for selecting pay contents to be purchased from a list of pay contents which is transmitted from the contents management center, when the access-requested contents are registered as being charged; a contents deletion specification means for specifying whether unpurchased contents other than the pay contents which is decided to be purchased by the purchase contents selection means are deleted or not; and a contents deletion information registration means for registering deletion information of the contents which is specified by the contents deletion specification means with the contents management center and the contents attribute-information in the contents storage area, and the recording/reproduction device includes: a contents deletion processing means for processing an area occupied by the contents registered by the contents deletion information registration means as a user available area where no contents exists.

Therefore, pay contents can be managed by the contents management center and, thus, an area occupied by pay contents that are not desired to be purchased by a user, among the pay contents stored in the recording medium of the recording/reproduction device at shipment, is processed as the user available area where no contents exists, thereby securing the area so that the user can record new contents therein.

According to claim 10 of the present invention, the recording/reproduction device as defined in claim 7 comprises: a purchase contents selection means for selecting contents to be purchased from a list of pay contents previously stored in the recording medium, which is transmitted from the contents management center; a contents deletion specification means for specifying whether unpurchased contents other than the pay contents which is decided to be purchased by the purchase contents selection means are deleted or not; and a contents deletion processing means for processing an area of the unpurchased contents that are specified by the contents deletion specification means as a user available area where no contents exists.

Therefore, it is possible to provide a recording/reproduction device which enables to process an area occupied by pay contents that are not desired to be purchased by a user, among pay contents previously stored in the recording medium at the shipment of the recording/reproduction device, as the user available area where no contents exists, thereby securing the area so that the user can record new contents therein.

According to claim 11 of the present invention, in the information supply method as defined in claim 4, in a case where the access-requested contents are registered as being charged, the access condition is set so that the access-requested pay contents are to be purchased in a certain purchase mode; when the user makes a purchase contents selection request to the contents management center, a list of pay contents, a contents purchase mode, and price information corresponding to the purchase mode, which are previously stored in the contents storage area are transmitted from the contents management center; when the user selects contents to purchase from the list of pay contents, as well as specifies a purchase mode of the selected contents from the contents purchase mode, pay contents purchase information of the pay contents decided to be purchased, and the purchase mode thereof are registered with the contents management center and the contents attribute information in the contents storage area and, after the registration, the pay contents are supplied to the user on the basis of the purchase mode.

Therefore, it is possible to realize a contents purchase method which meets user's various demands.

According to claim 12 of the present invention, in the information supply system as defined in claim 5, the contents management center comprises: a purchase contents selection means for selecting pay contents to be purchased from a list of pay contents which is transmitted from the contents management center, when the user requests an access to the pay contents in the contents storage area; a purchase mode specification means for specifying a purchase mode of the pay contents to be purchased from contents purchase mode information which is transmitted from the contents management center in concurrence with the list of pay contents; and a purchase mode information registration means for registering the purchase mode of the pay contents which is specified by the purchase mode specification means with the contents management center and the contents attribute information in the contents storage area, and the recording/reproduction device includes: an access control storage means for storing a state of a user access to the pay contents in order to control the same on the basis of the purchase mode of the pay contents registered by the purchase mode information registration means.

Therefore, pay contents previously stored in the recording medium at the shipment of the recording/reproduction device can be supplied in a purchase mode specified from various purchase modes by a user.

According to claim 13 of the present invention, in the recording/reproduction device as defined in claim 7, the access condition setting means sets a condition of an access to the contents to be purchased on the basis of a purchase mode of the pay contents to be purchased, which is registered with the contents attribute information and specified by the user, and an access control storage means is provided to store a state of a user access to the contents in order to control the same according to the access condition.

Therefore, it is possible to provide a recording/reproduction device which enables to supply pay contents that are previously recorded in the recording medium of the recording/reproduction device at shipment, according to various purchase modes.

According to claim 14 of the present invention, in the information supply method as defined in claim 4, the contents which can be used by the user, and the contents attribute information including the information indicating whether the contents are charged or free, and contents time information indicating a time value of the contents are previously recorded in the contents storage area of the recording medium; in a case where the access-requested pay contents are registered as being charged, the access condition is set so that the access-requested pay contents are to be purchased; when the user makes a purchase contents selection request to the contents management center, a list of pay contents and price information corresponding to the contents time information, which are previously stored in the contents storage area are transmitted from the contents management center; when the user selects contents to purchase from the list of pay contents, the pay contents purchase information of the pay contents decided to be purchased is registered with the contents management center and the contents attribute information in the contents storage area, and then the pay contents are supplied to the user, while in a case where the access-requested contents are registered as being free, the access condition is set according to the contents time information, and the free contents are supplied to the user on the basis of the access condition, and free contents which have no time value according to the contents time information are not provided to the user, and an area thereof is processed as a user available area where no contents exists.

Therefore, when contents stored in the recording medium of the recording/reproduction device is supplied to a user, a time value of the contents can be reflected on a purchase price thereof.

According to claim 15 of the present invention, in the information supply system as defined in claim 5, the contents which can be used by the user and the contents attribute information including the information indicating whether the contents are charged or free, and contents time information indicating a time value of the contents are previously recorded in the contents storage area, and the recording/reproduction device includes: a purchase contents selection means for selecting pay contents to be purchased from a list of pay contents and price information corresponding to the contents time information, which are transmitted from the contents management center, when the access-requested contents are registered as being charged; and a contents management means for processing an area occupied by contents having no time value according to the contents time information, as a user available area where no contents exists, when the accessed contents are registered as being free.

Therefore, it is possible to supply a user with pay contents that is previously stored in the recording medium at the shipment of the recording/reproduction device, reflecting a time value of the contents on a purchase price thereof.

According to claim 16 of the present invention, in the recording medium as defined in claim 3, the contents which can be used by the user, and contents attribute information including information indicating whether the contents are charged or free, and contents time information indicating time values of the contents are previously recorded in the contents storage area.

Therefore, a time value of contents can be reflected on a contents purchase price.

According to claim 17 of the present invention, the recording/reproduction device as defined in claim 7 includes: a contents management means for processing an area occupied by free contents on the recording medium that has no time value according to contents time information indicating time values of the contents which is previously stored in the contents storage area, as a user available area where no contents exists.

Therefore, it is possible to provide a recording/reproduction device which enables to provide contents that is previously stored in the recording medium at the shipment of the recording/reproduction device, reflecting a time value of the contents on a purchase price thereof.

According to claim 18 of the present invention, in the information supply method as defined in claim 1, the contents are supplied to the user according to control of a contents management center which is connected with the recording/reproduction device via a communication line, system setup data for each use area, which is required to set up the recording/reproduction device, and use area information indicating a use area corresponding to the system setup data are previously stored in the contents storage area, and in the recording/reproduction device, it is checked whether the system setup data corresponding to a use area inputted by the user is stored in the contents storage area or not, with reference to the use area information; when the system setup data corresponding to the use area is stored in the contents storage area, the use area is registered with the contents management center and the use area information in the contents storage area, and the system setup data corresponding to the use area is supplied to the user, and an area occupied by system setup data other than the provided system setup data, which are previously stored in the contents storage area is processed as a user available area where no contents exists.

Therefore, it is possible to reduce the time required to set up a system of the recording/reproduction device.

According to claim 19 of the present invention, in the information supply system as defined in claim 2 comprising: the recording/reproduction device which is supplied to the user with system setup data for each use area, which is required to set up the recording/reproduction device, and use area information indicating a use area corresponding to the system setup data, being previously recorded in the contents storage area of the recording medium; and a contents management center which is connected to the recording/reproduction device via a communication line and manages the system setup data recorded in the contents storage area, the recording/reproduction device includes: a use area information reference means for referring to the use area information indicating the use area corresponding to the setup data, which is stored in the contents storage area; a data access control means for providing the user with the system setup data corresponding to the use area from the contents storage area, so that the provided system setup data is used for setup; and a data deletion processing means for processing an area occupied by system setup data other than the system setup data provided by the data access control means, which are previously stored in the contents storage area, as a user available area where no data exists, and the contents management center comprises: a use area information registration means for registering the use area inputted by the user with the contents management center and the use area information in the contents storage area; and an access permission means for permitting the user to access the system setup data corresponding to the use area on the basis of the use area information registration means.

Therefore, the recording/reproduction device can be set up by employing the system setup data which is previously stored in the recording medium at the shipment of the recording/reproduction device and, further, the time required to set up a system of the recording/reproduction device can be reduced.

According to claim 20 of the present invention, in the recording medium as defined in claim 3, system setup data for each use area, which is required to set up the recording/reproduction device, and use area information indicating a use area corresponding to the system setup data are previously recorded in the contents storage area.

Therefore, the system setup data for setting up a system of the recording/reproduction device can be recorded on the recording medium correspondingly to an area where the recording/reproduction device is used by a user.

According to claim 21 of the present invention, in the recording/reproduction device connected to the contents management center in the information supply system as defined in claim 19, the recording/reproduction device includes: the use area information reference means for referring to the use area information stored in the recording medium when the user inputs a use area where the recording/reproduction device is used, at setup; the data access control means for providing the user with the system setup data corresponding to the inputted use area, so that the provided system setup data is used for setup; and the data deletion processing means for processing the area occupied by the system setup data other than the system setup data provided by the data access control means, which are previously stored in the contents storage area, as the user available area where no data exists.

Therefore, it is possible to provide a recording/reproduction device which is set up by employing the system setup data previously stored in the recording medium at the shipment of the recording/reproduction device, and enables to reduce the time required to set up a system of the recording/reproduction device.

### BRIEF DESCRIPTION OF DRAWINGS

FIG. 1 is a diagram illustrating a state of a built-in recording medium at the shipment of a recording/reproduction device according to a first embodiment of the present invention.

FIG. 2 is a diagram illustrating a state of a built-in recording medium at the shipment of a recording/reproduction device according to a second embodiment of the present invention.

FIG. 3 is a diagram illustrating the construction of an information supply system according to the second embodiment of the invention.

FIG. 4 is a diagram illustrating the processing when a user requests an access to contents after purchasing the recording/reproduction device, according to the second embodiment of the invention.

FIG. 5 is a diagram illustrating a state of a built-in recording medium at the shipment of a recording/reproduction device according to a third embodiment of the present invention.

FIG. 6 is a diagram illustrating the construction of an information supply system according to the third embodiment of the invention.

FIG. 7 is a diagram illustrating the processing when a user makes a contents purchase request after purchasing the recording/reproduction device, according to the third embodiment of the invention.

FIG. 8 is a diagram illustrating a state of a built-in recording medium at the shipment of a recording/reproduction device according to a fourth embodiment of the present invention.

FIG. 9 is a diagram illustrating the construction of an information supply system according to the fourth embodiment of the invention.

FIG. 10 is a diagram illustrating the processing when a user makes a contents purchase request after purchasing the recording/reproduction device, according to the fourth embodiment of the invention.

FIG. 11 is a diagram illustrating a state of a built-in recording medium at the shipment of a recording/reproduction device according to a fifth embodiment of the present invention.

FIG. 12 is a diagram illustrating the construction of an information supply system according to the fifth embodiment of the invention.

FIG. 13 is a diagram illustrating the processing when a user makes a contents purchase request after purchasing the recording/reproduction device, according to the fifth embodiment of the invention.

FIG. 14 is a diagram illustrating a state of a built-in recording medium at the shipment of a recording/reproduction device according to a sixth embodiment of the present invention.

FIG. 15 is a diagram illustrating the construction of an information supply system according to the sixth embodiment of the invention.

FIG. 16 is a diagram illustrating the processing when a user sets up the recording/reproduction device after purchasing the same, according to the sixth embodiment of the invention.

FIG. 17 is a diagram illustrating a state of a recording medium used in a recording/reproduction device at shipment, in a conventional information supply method and system.

### BEST MODE TO EXECUTE THE INVENTION

(Embodiment 1)

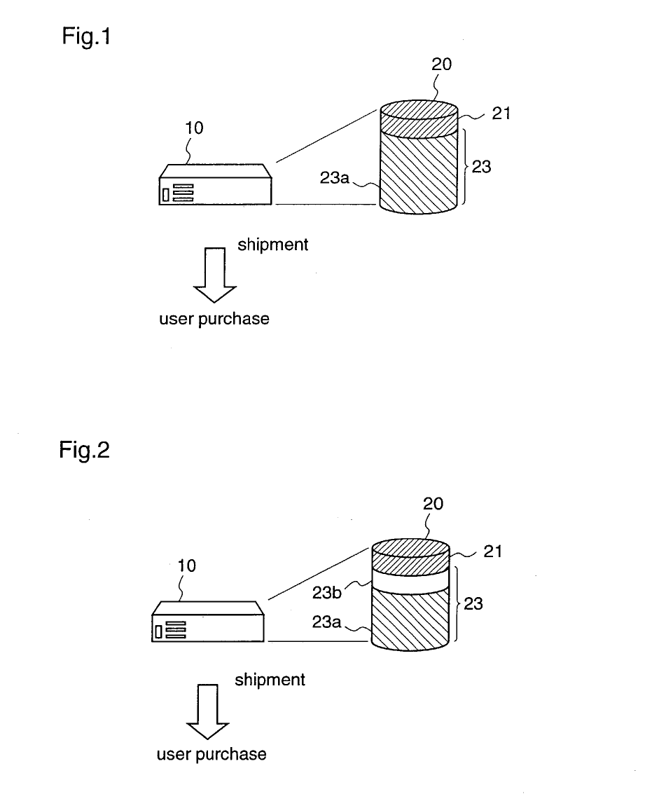

Hereinafter, a first embodiment of the present invention will be described with reference to FIG. 1. FIG. 1 is a diagram illustrating a state of a built-in recording medium at the shipment of a recording/reproduction device according to the first embodiment.

With reference to FIG. 1, a built-in recording medium 20 of a recording/reproduction device 10 at shipment according to the first embodiment comprises a system using area 21 and a contents storage area 23. The system using area 21 contains information used by the recording/reproduction device 10 to be started. In the contents storage area 23 which constitutes a major portion of the built-in recording medium 20, contents 23a which can be used by a user are previously recorded. Thus, the user gets the contents 23a stored in the built-in recording medium 20 when purchasing the recording/reproduction device 10.

As described above, according to the first embodiment, the recording/reproduction device 10 is shipped with its built-in recording medium 20 previously containing the contents 23a which can be used by a user, whereby the contents can be provided to the user who has purchased the recording/reproduction device 10 without constructing new contents distribution channels for providing contents, resulting in more opportunities for contents distribution.

While in the first embodiment the built-in recording medium 20 provided in the recording/reproduction device 10 is a recording medium on which the contents are previously stored, the recording medium needs not be built therein but may be attached externally.

(Embodiment 2)

Hereinafter, a second embodiment of the present invention will be described with reference to FIGS. 2 to 4.

Initially, a description will be given of a state of a built-in recording medium 20 in a recording/reproduction device 10 at shipment according to the second embodiment, with reference to FIG. 2. FIG. 2 is a diagram illustrating the state of the built-in recording medium at the shipment of the recording/reproduction device according to the second embodiment.

With reference to FIG. 2, the built-in recording medium 20 of the recording/reproduction device 10 at shipment according to the second embodiment comprises a system using area 21 containing information used by the recording/reproduction device 10 to be started, and a contents storage area 23 which constitutes a major portion of the built-in recording medium 20. The contents storage area 23 contains plural pay/free contents 23a which can be used by a user, and contents attribute information 23b which indicates whether the respective plural contents 23a are charged for or free. Thus, the user gets the pay/free contents 23a stored in the built-in recording medium 20 when purchasing the recording/reproduction device 10.

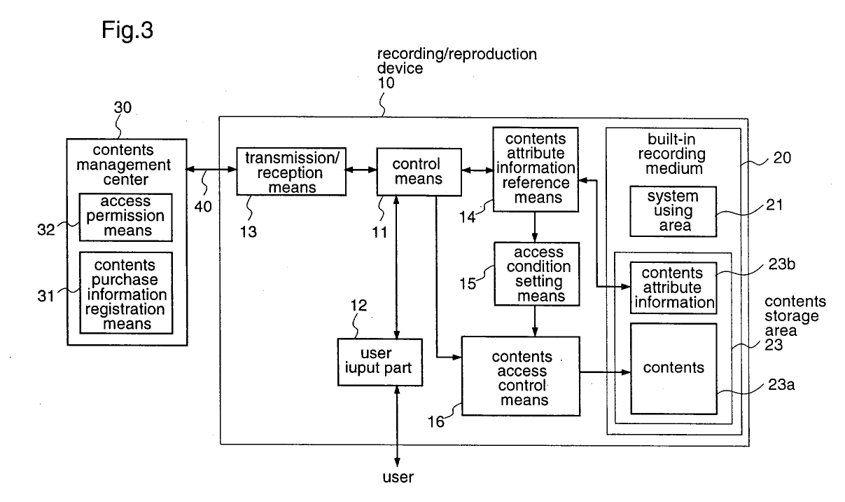

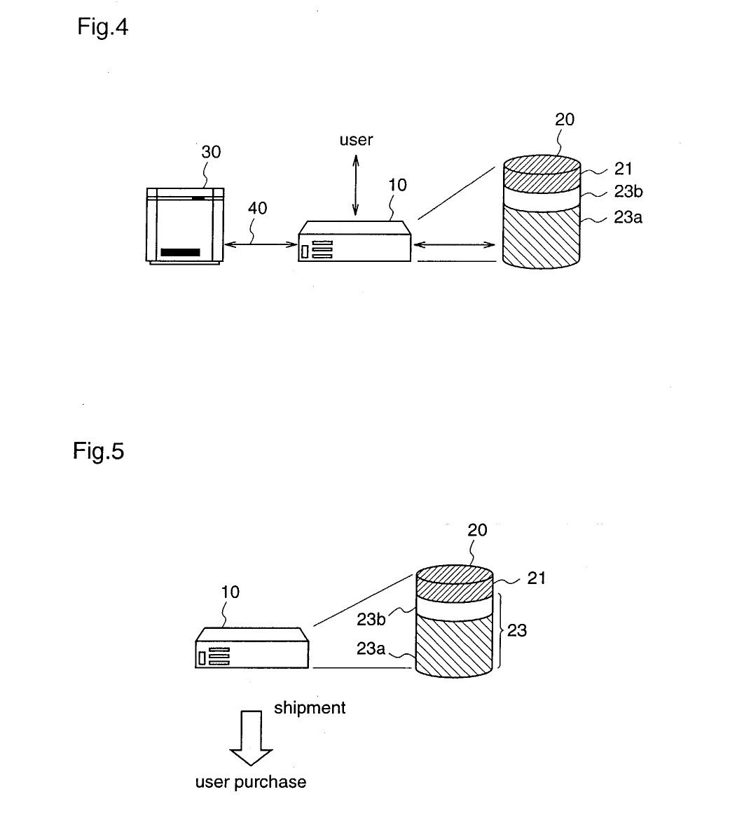

Next, a description will be given of the processing until the user obtains the contents 23a stored in the built-in recording medium 20 of the recording/reproduction device 10 after purchasing the recording/reproduction device 10, with reference to FIGS. 3 and 4. FIG. 3 is a diagram illustrating the construction of an information supply system according to the second embodiment, when the user requests an access to certain contents after purchasing the recording/reproduction device. FIG. 4 is a diagram illustrating the processing when the user requests an access to the contents after purchasing the recording/reproduction device in the second embodiment.

Initially, the construction of the information supply system according to the second embodiment will be described with reference to FIG. 3.

In FIG. 3, numeral 30 denotes a contents management center, which manages an access to pay contents previously stored in the built-in recording medium 20 of the recording/reproduction device 10, and has a contents purchase information registration means 31 and an access permission means 32. The contents purchase information registration means 31 registers pay contents which is desired to be purchased by a user with both of the contents attribute information 23b in the built-in recording medium 20 and the contents management center 30. The access permission means 32 permits provision of the pay contents in the contents storage area 23 to the user. Numeral 40 denotes a communication line connecting between the contents management center 30 and the recording/reproduction device 10.

The recording/reproduction device 10 comprises a control part 11 for controlling the operation of the recording/reproduction device 10, a user input part 12 for receiving an input from a user, a transmission/reception means 13 which connects the contents management center 30 and the recording/reproduction means 10 via the communication line 40, to transmit/receive data and control information, a contents attribute information reference means 14 for referring to the contents attribute information 23b stored in the built-in recording medium 20, an access condition setting means 15 for setting a condition of an access to contents on the basis of the contents attribute information 23b referred to by the contents attribute information reference means 14, a contents access control means 16 for controlling contents provision to the user on the basis of the access condition set by the access condition setting means 15, and the built-in recording medium 20.

Next, a description will be given of the processing operation of the information supply system according to the second embodiment until contents stored in the built-in recording medium 20 of the recording/reproduction device 10 is supplied to a user.

Initially, when a user issues a request for an access to certain contents among the plural contents 23a stored in the built-in recording medium 20, to the recording/reproduction device 10 through the user input part 12, the recording/reproduction device 10 reads the contents attribute information 23b on the built-in recording medium 20 by the contents attribute information reference means 14, to confirm whether the attribute of the target contents accessed by the user is “free” or “charged”.

When the attribute of the target contents is “free”, the access condition setting means 15 sets a condition of access to the target contents as “no-condition”, and the target contents previously stored in the contents storage area 23 is supplied to the user by the contents access control means 16 without condition.

On the other hand, when the attribute of the target contents is “charged”, the access condition setting means 15 sets the condition of access to the target contents so that pay contents are to be purchased under management of the contents management center 30, data is transmitted/received to/from the contents management center 30, and when the user decides to purchase the pay contents, the access permission means 32 permits an access to the pay contents, and the pay contents are provided to the user by the contents access control means 16.

Hereinafter, a detailed description will be given of the processing operation when the attribute of the access-requested contents is “charged”.

When the attribute of the contents which are desired to be accessed by a user is “charged”, the recording/reproduction device 10 is initially connected with the contents management center 30 via the communication line 40. Then, the transmission/reception means 13 receives price information of the target contents from the contents management center 30 through the communication line 40, and the received price information is supplied to the user. When the user decides to purchase the target contents, purchase information of the pay contents is registered with the contents management center 30 and the contents attribute information 23b in the built-in recording medium 20 by the contents purchase information registration means 31. At this point of time, provision of the pay contents is permitted by the access permission means 32 of the contents management center 30, and the contents are provided to the user by the contents access control means 16. When the user purchases certain pay contents on the recording medium 20 and purchase information of the pay contents are registered with the contents attribute information 23b once by the contents purchase information registration means 31, a subsequent access to the purchase-registered pay contents is permitted unconditionally without connecting to the contents management center 30.

As described above, according to the second embodiment, plural contents 23a which can be used by a user, and contents attribute information 23b indicating whether the contents are charged or free are previously stored in the built-in recording medium 20 of the recording/reproduction device 10, whereby the contents can be provided to the user who has purchased the recording/reproduction device 10 without constructing new contents distribution channels for providing contents, resulting in more opportunities for contents distribution. Further, since the contents attribute information 23b is stored in the built-in recording medium 20 of the recording/reproduction device 10, free contents and pay contents can be mixedly stored as the contents 23a stored in the built-in recording medium 20.

While in the second embodiment the built-in recording medium 20 provided in the recording/reproduction device 10 is a recording medium on which the contents are previously stored, the recording medium needs not be built therein but may be attached externally.

(Embodiment 3)

Hereinafter, a third embodiment of the present invention will be described with reference to FIGS. 5 to 8.

Initially, a description will be given of a state of a built-in recording medium 20 in a recording/reproduction device 10 at shipment according to the third embodiment, with reference to FIG. 5. FIG. 5 is a diagram illustrating the state of the built-in recording medium at the shipment of the recording/reproduction device according to the third embodiment.

With reference to FIG. 5, the state of the built-in recording medium 20 of the recording/reproduction device 10 at shipment according to the third embodiment is identical to that described as the second embodiment, and a user gets plural pay/free contents stored in the built-in recording medium 20 when purchasing the recording/reproduction device 10.

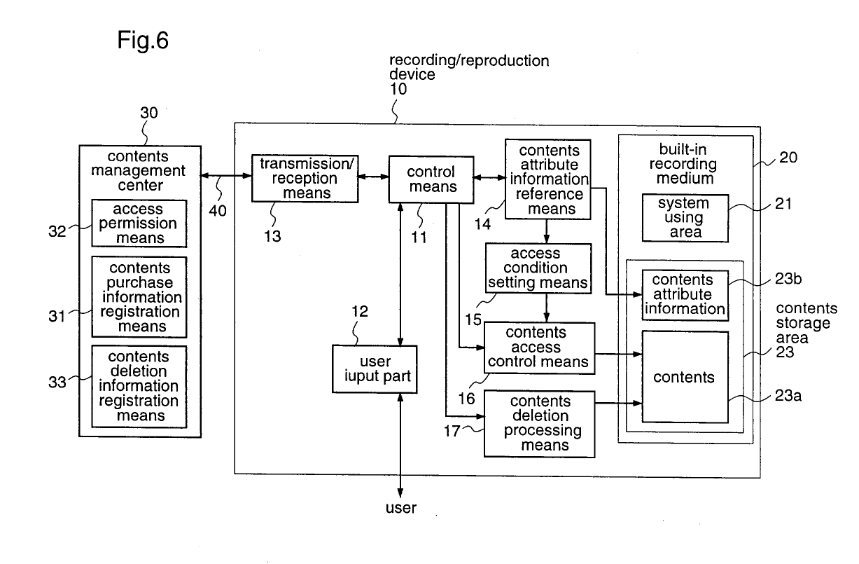

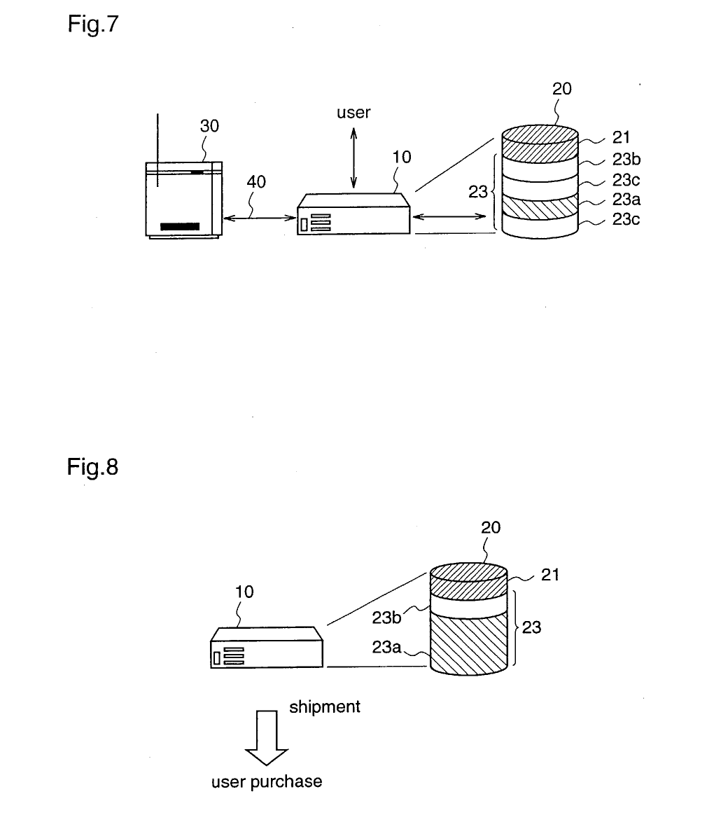

Next, a description will be given of the processing until the user obtains contents 23a stored in the built-in recording medium 20 of the recording/reproduction device 10 after purchasing the recording/reproduction device 10, with reference to FIGS. 6 and 7. FIG. 6 is a diagram illustrating the construction of an information supply system according to the third embodiment, when the user makes a contents purchase request with respect to certain contents after purchasing the recording/reproduction device. FIG. 7 is a diagram illustrating the processing when the user makes the contents purchase request after purchasing the recording/reproduction device in the third embodiment.

Initially, the construction of the information supply system according to the third embodiment will be described with reference to FIG. 6.

In FIG. 6, a contents management center 30 according to the third embodiment further includes a contents deletion information registration means 33 for registering contents deletion information, which is information on contents specified to be deleted by a user, among unpurhcased contents other than pay contents decided to be purchased by the user, which are previously recorded in the built-in recording medium 20, with both of the contents management center 30 and contents attribute information 23b in a contents storage area 23. Further, the recording/reproduction device 10 of the third embodiment further includes a contents deletion processing means 17 for processing an area occupied by the contents registered by the contents deletion information registration means 33 as a user available area where no contents exists. Other constituents are identical to those of the second embodiment, and descriptions thereof will be omitted here.

Next, a description will be given of the processing operation of the information supply system according to the third embodiment until the contents 23a stored in the built-in recording medium 20 of the recording/reproduction device 10 is supplied to a user, with reference to FIGS. 6 and 7.

Initially, when a user issues a request for an access to certain contents among the plural contents 23a stored in the built-in recording medium 20, to the recording/reproduction device 10 through the user input part 12, the recording/reproduction device 10 reads the contents attribute information 23b in the built-in recording medium 20 by the contents attribute information reference means 14, to confirm whether an attribute of the target contents is “free” or “charged”.

When the attribute of the target contents is “free”, the access condition setting means 15 sets a condition of an access to the target contents as “no-condition”, and the target contents previously stored in the contents storage area 23 are provided to the user without condition by the contents access control means 16.

On the other hand, when the attribute of the target contents is “charged”, the access condition setting means 15 sets the condition of the access to the target contents so that pay contents are to be purchased under management of the contents management center 30, data are transmitted/received to/from the contents management center 30, and when the user decides to purchase the pay contents, the access permission means 32 permits an access to the pay contents, and the pay contents are provided to the user by the contents access control means 16.

Hereinafter, a detailed description will be given of the processing operation when the attribute of the access-requested contents is “charged”.

When the attribute of the contents which are requested to be accessed by a user through the user input part 12 is “charged”, initially the user issues a purchase contents selection request to the contents management center 30 through the user input part 12, and the recording/reproduction device 10 is connected with the contents management center 30 via the communication line 40. When the contents management center 30 connected with the recording/reproduction device 10 receives the purchase contents selection request, a list of pay contents and price information thereof which are stored in the built-in recording medium 20 are provided to the user by the transmission/reception means 13 through the communication line 40. The user selects desired contents from the list of pay contents through the user input part 12, and decides contents to purchase. Then, pay contents purchase information, which is information on the contents decided to be purchased is registered with both of the contents management center 30 and the contents attribute information 23b in the built-in recording medium 20 by the contents purchase information registration means 31. At this point of time, the access permission means 32 of the contents management center 30 permits supply of the pay contents decided to be purchased, and the pay contents are supplied to the user by the contents access control means 16.

Then, the user specifies through the user input part 12 contents to be deleted among the unpurchased contents in the contents storage area 23, which are contents other than the pay contents registered by the contents purchase information registration means 31, and information on the specified contents is registered with both of the contents management center 30 and the contents attribute information 23b in the built-in recording medium 20, as the contents deletion information by the contents deletion information registration means 33.

When the contents deletion information is registered with the contents attribute information 23b by the contents deletion information registration means 33, the contents deletion processing means 17 processes an area of the deletion-specified pay contents in the contents storage area 23 as a user available area 23c where no contents exists, so that the user can record new contents therein.

As described with respect to the second embodiment, when there is a request for an access to pay contents which has been purchased by a user once, the contents are provided unconditionally without accessing the contents management center 30.

As described above, according to the third embodiment, with respect to the pay contents which are not desired to be purchased by a user, among pay contents stored in the built-in recording medium 20 of the recording/reproduction device 10 at shipment, the contents deletion information registration means 33 registers contents deletion information with the contents attribute information 23b through the contents management center 30, and the contents deletion processing means 17 processes an area occupied by the pay contents which are registered to be deleted as the user available area 23c where no contents exists so that the user can use it, thereby securing an area to record new contents therein on the built-in recording medium 20 of the recording/reproduction device 10. Further, since it can be managed by the contents management center 30 which contents has been purchased and deleted by the user, it is possible to obtain information on user trends of contents purchase.

While in the third embodiment the built-in recording medium 20 provided inside the recording/reproduction device 10 is a recording medium on which the contents are previously stored, the recording medium needs not be built therein but may be attached externally.

(Embodiment 4)

Hereinafter, a fourth embodiment of the present invention will be described with reference to FIGS. 8 to 10.

Initially, a description will be given of a state of a built-in recording medium 20 in a recording/reproduction device 10 at shipment according to the fourth embodiment, with reference to FIG. 8. FIG. 8 is a diagram illustrating the state of the built-in recording medium at the shipment of the recording/reproduction device according to the fourth embodiment.

With reference to FIG. 8, the state of the built-in recording medium 20 in the recording/reproduction device 10 at shipment according to the fourth embodiment is identical to that described as the second embodiment, and a user gets plural pay/free contents 23a stored in the built-in recording medium 20 when purchasing the recording/reproduction device 10.

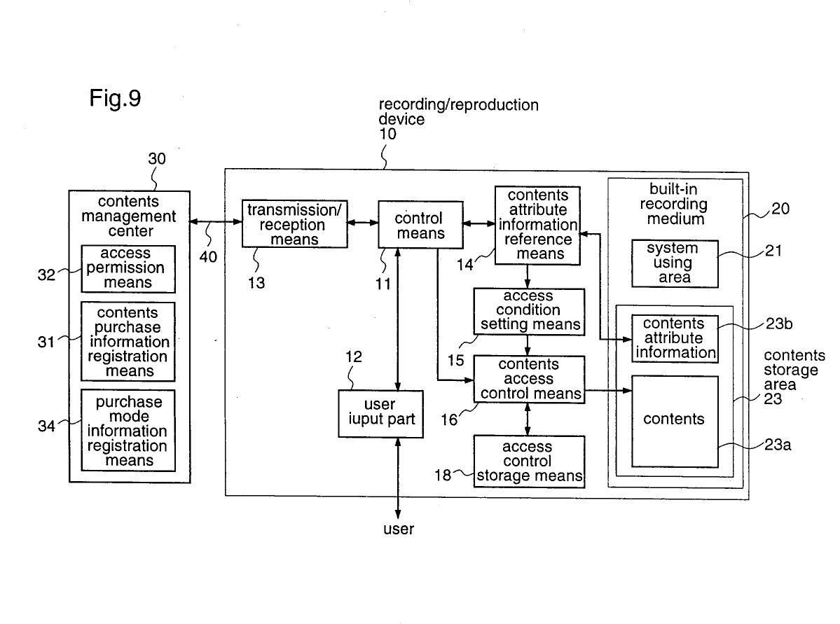

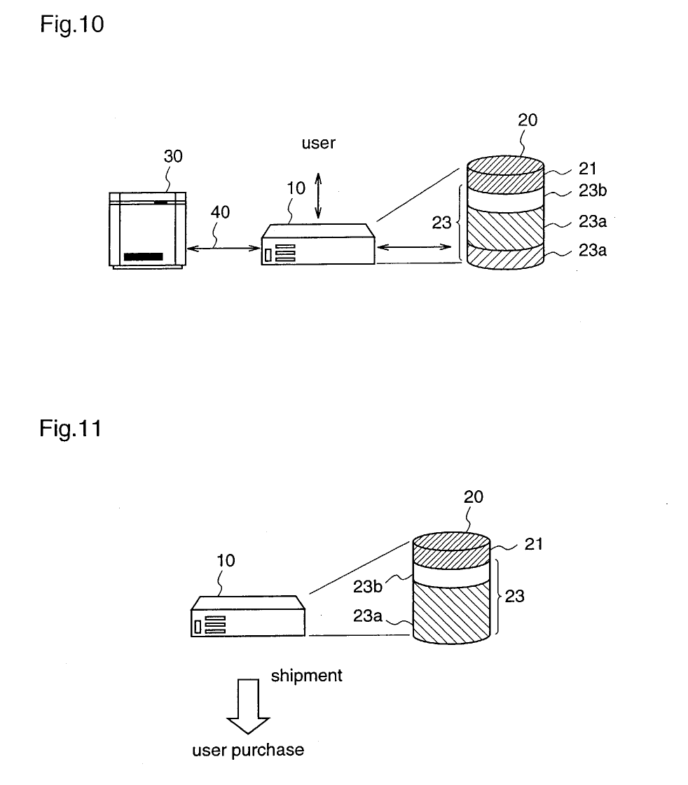

Next, a description will be given of the processing until the user obtains the contents 23a stored in the built-in recording medium 20 of the recording/reproduction device 10 after purchasing the recording/reproduction device 10, with reference to FIGS. 9 and 10. FIG. 9 is a diagram illustrating a construction of an information supply system according to the fourth embodiment, when the user makes a contents purchase request with respect to certain contents after purchasing the recording/reproduction device. FIG. 10 is a diagram illustrating the processing when the user makes the contents purchase request after purchasing the recording/reproduction device in the fourth embodiment.

Initially, the construction of the information supply system according to the fourth embodiment will be described with reference to FIG. 9.

In FIG. 9, a contents management center 30 according to the fourth embodiment further includes a purchase mode information registration means 34 for registering a purchase mode of pay contents, which is specified by a user at the same time when the user decides to purchase the pay contents from contents preciously stored in the built-in recording medium 20, with the contents management center 30 and the contents attribute information 23b in the contents storage area 23. Further, the recording/reproduction device 10 according to the fourth embodiment further includes an access control storage means 18 for storing a state of an access to the contents from a user in order to control a user access to the contents on the basis of the contents purchase mode registered with the contents attribute information 23b by the purchase mode information registration means 34. Other constituents are identical to those of the second embodiment, and descriptions thereof will be omitted here.

Next, a description will be given of the processing operation of the information supply system according to the fourth embodiment until the contents 23a stored in the built-in recording medium 20 of the recording/reproduction device 10 is supplied to a user, with reference to FIGS. 9 and 10.

Initially, when a user issues a request for an access to certain contents among the plural contents 23a stored in the built-in recording medium 20, to the recording/reproduction device 10 through the user input part 12, the recording/reproduction device 10 reads the contents attribute information 23b in the built-in recording medium 20 by the contents attribute information reference means 14, to confirm whether an attribute of the target contents is “free” or “charged”.

When the attribute of the target contents is “free”, the access condition setting means 15 sets a condition of an access to the target contents as “no-condition”, and the target contents previously stored in the contents storage area 23 is supplied to the user without condition by the contents access control means 16.

On the other hand, when the attribute of the target contents is “charged”, the access condition setting means 15 sets the condition of the access to the target contents so that pay contents are to be purchased in a certain purchase mode under management of the contents management center 30, data is transmitted/received to/from the contents management center 30, and when the user decides to purchase the pay contents in the certain purchase mode, the access permission means 32 permits access to the pay contents, and the pay contents are supplied to the user by the contents access control means 16.

Hereinafter, a detailed description will be given of the processing operation when the attribute of the access-requested contents is “charged”.

When the attribute of the contents which is requested to be accessed by a user through the user input part 12 is “charged”, initially the user issues a purchase contents selection request to the contents management center 30 through the user input part 12, and the recording/reproduction device 10 is connected with the contents management center 30 via the communication line 40. When the contents management center 30 connected with the recording/reproduction device 10 receives the purchase contents selection request, a list of pay contents, a contents purchase mode, and price information corresponding to the contents purchase mode, which are stored in the built-in recording medium 20 are provided to the user by the transmission/reception means 13 through the communication line 40. The user selects desired contents from the list of pay contents through the user input part 12, as well as specifies a purchase mode of the contents through the user input part 12, and decides contents to purchase and a purchase mode of the contents. Then, pay contents purchase information, which is information on the contents decided to be purchased is registered with both of the contents management center 30 and the contents attribute information 23b in the built-in recording medium 20 by the contents purchase information registration means 31, and contents purchase mode information, which is information on the purchase mode of the contents decided to be purchased is registered with both of the contents management center 30 and the contents attribute information 23b in the built-in recording medium 20 by the purchase mode information registration means 34. At this point of time, the access permission means 32 of the contents management center 30 permits supply of the pay contents decided to be purchased in the above-mentioned contents purchase mode, and the pay contents are given to the user by the contents access control means 16.

Provided that a user decides to purchase contents A which is previously stored in the contents storage area 23 in a purchase mode where the number of times that the contents is reproduced is restricted. In this case, when the user requests an access to the contents A through the user input part 12, the number of reproductions of the contents A is stored by the access control storage means 18, so that the contents A is supplied to the user within the restriction. Further, provided that a user decides to purchase contents B which is previously stored in the contents storage area 23 in a purchase mode where the number of times that the contents is reproduced is not restricted. In this case, when the user requests an access to the contents B through the user input part 12, the contents are supplied to the user every time a contents access request is issued, regardless of the number of times that the contents B is reproduced. The contents purchase mode is reflected on a contents purchase price by, for example, setting the contents purchase price when the contents purchase mode is “restriction on the number of reproductions” lower than the contents purchase price when the contents purchase mode is “no restriction on the number of reproductions”.

Further, when there is a request for an access to pay contents which has been purchased by a user once, there is no need of accessing the contents management center 30 as described in the second embodiment, and the contents are supplied to the user on the basis of the contents purchase mode information registered with the contents attribute information 23b.

As described above, according to the fourth embodiment, a user selects a purchase mode of pay contents when purchasing the contents, a state of an access to the selected pay contents is stored by the access control storage means 18 of the recording/reproduction device 10, and the contents are supplied to the user under access restrictions according to the contents purchase mode, thereby providing the pay contents in a purchase mode desired by the user, resulting in a contents purchase method meeting user's various demands.

While in the fourth embodiment a recording medium on which the contents are previously stored is the built-in recording medium 20 provided inside the recording/reproduction device 10, the recording medium needs not be built therein but may be attached externally.

(Embodiment 5)

Hereinafter, a fifth embodiment of the present invention will be described with reference to FIGS. 11 to 13.

Initially, a description will be given of a state of a built-in recording medium 20 in a recording/reproduction device 10 at shipment according to the fifth embodiment, with reference to FIG. 11. FIG. 11 is a diagram illustrating the state of the built-in recording medium at the shipment of the recording/reproduction device according to the fifth embodiment.

With reference to FIG. 11, contents attribute information 23b according to the fifth embodiment previously contains pay/free information on contents which can be used by a user, and contents time information which indicates time value of each contents. The contents time information indicates, for example, a recording time when the contents are recorded in the built-in recording medium 20 of the recording/reproduction device 10, an expiration date of the contents or the like. The state of the built-in recording medium 20 of the recording/reproduction device 10 at shipment according to the fifth embodiment as for the rest is identical to that described in the second embodiment, and a user gets plural pay/free contents 23a stored in the built-in recording medium 20 when purchasing the recording/reproduction device 10.

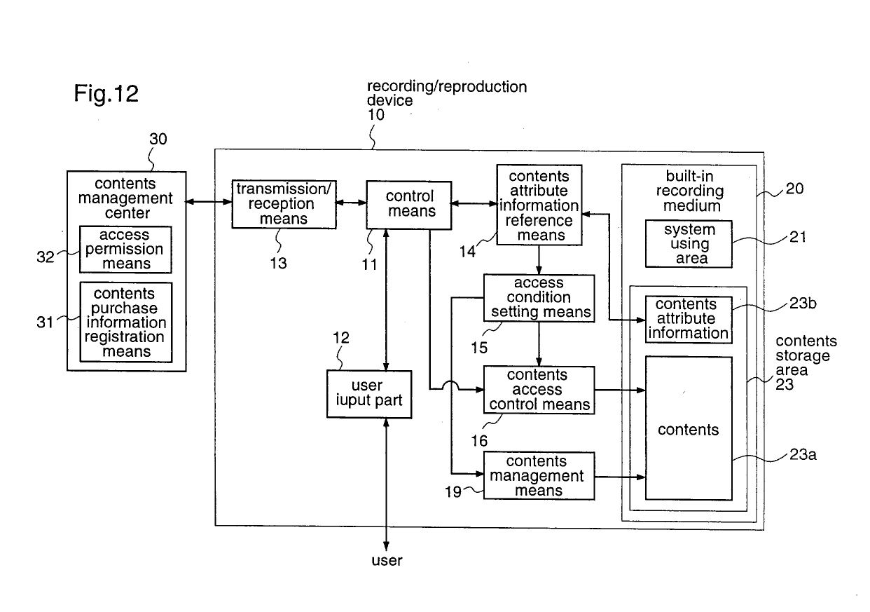

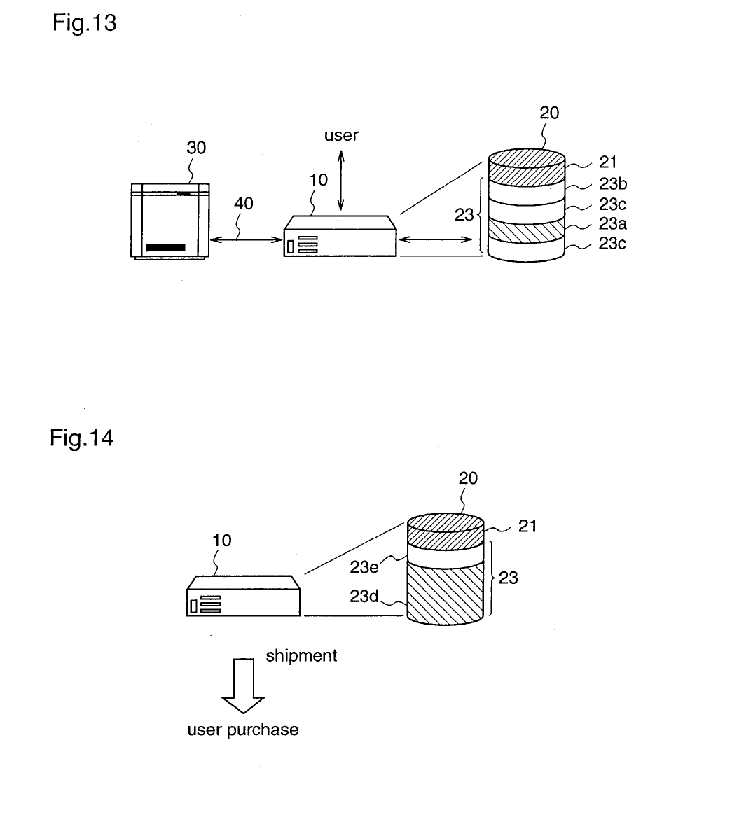

Next, a description will be given of the processing until the user obtains the contents 23a stored in the built-in recording medium 20 of the recording/reproduction device 10 after purchasing the recording/reproduction device 10, with reference to FIGS. 12 and 13. FIG. 12 is a diagram illustrating the construction of an information supply system according to the fifth embodiment, when the user makes a contents purchase request with respect to certain contents after purchasing the recording/reproduction device. FIG. 13 is a diagram illustrating the processing when the user makes the contents purchase request after purchasing the recording/reproduction device in the fifth embodiment.

Initially, the construction of the information supply system according to the fifth embodiment will be described with reference to FIG. 12.

In FIG. 12, the recording/reproduction device 10 according to the fifth embodiment further includes a contents management means 19 for managing the plural contents 23a in the contents storage area 23 on the basis of the contents time information which is previously stored in the contents attribute information 23b in the built-in recording medium 20. Other constituents are identical to those of the second embodiment, and descriptions thereof will be omitted here.

Next, a description will be given of the processing operation of the information supply system according to the fifth embodiment until the contents 23a stored in the built-in recording medium 20 of the recording/reproduction device 10 is supplied to a user, with reference to FIGS. 12 and 13.

Initially, when a user issues a request for an access to certain contents among the plural contents 23a stored in the built-in recording medium 20, to the recording/reproduction device 10 through the user input part 12, the recording/reproduction device 10 reads the contents attribute information 23b in the built-in recording medium 20 by the contents attribute information reference means 14, to confirm whether an atttibute of the target contents is “free” or “charged”, and the contents time information of the target contents.

When the attribute of the target contents is “free”, the access condition setting means 15 sets a condition of an access to the target contents on the basis of the contents time information stored in the contents attribute information 23b, and the target contents previously stored in the contents storage area 23 is supplied to the user by the contents access control means 16 on the basis of the access condition.

Provided that the contents time information indicates an expiration date of free contents. In this case, when it is confirmed by the contents attribute information reference means 14 that an attribute of contents C which is requested to be accessed by a user is “free” and “before free expiration date”, the access condition setting means 15 sets the condition of access to the contents as “no-condition”, and the contents are supplied to the user without condition by the contents access control means 16. Further, when the user requests an access to other contents D, and it is confirmed by the contents attribute information reference means 14 that an attribute of the contents D is “free” but “after free expiration data”, the access condition setting means 15 sets the access condition as “inaccessible”, and the contents D is not provided to the user. In this case, the contents management means 19 processes an area occupied by the contents D as a user available area 23c where no contents exists, so that the user can record new contents therein.

On the other hand, when the attribute of the target contents is “charged”, the access condition setting means 15 sets a condition of an access to the target contents so that contents are to be purchased at a price reflecting the contents time information under management of the contents management center 30, data is transmitted/received to/from the contents management center 30, and when the user decides to purchase the pay contents, the access permission means 32 permits access to the pay contents, and the pay contents are supplied to the user by the contents access control means 16.

Hereinafter, a description will be given of the processing when the attribute of the access-requested contents is “charged”, and the contents time information indicates a recording time when the contents are recorded in the built-in recording medium 20.

When the attribute of the contents which is requested to be accessed by a user through the user input part 12 is “charged”, initially the user issues a purchase contents selection request to the contents management center 30 through the user input part 12, and the recording/reproduction device 10 is connected with the contents management center 30 via the communication line 40. When the contents management center 30 connected to the recording/reproduction device 10 receives the purchase contents selection request, a list of pay contents and price information corresponding to the time information of each contents, which are stored in the built-in recording medium 20 are provided to the user by the transmission/reception means 13 through the communication line 40. The user selects desired pay contents from the list of pay contents through the user input part 12, and decides pay contents to purchase. Then, pay contents purchase information which is information on the pay contents decided to be purchased by the user is registered with both of the contents management center 30 and the contents attribute information 23b on the built-in recording medium 20 by the contents purchase information registration means 31. At this point of time, the access permission means 32 of the contents management center 30 permits supply of the pay contents decided to be purchased, and the pay contents are given to the user by the contents access control means 16. It is judged that the time value is lower when the elapsed time from the recording time stored in the built-in recording medium 20 to a time point when the access is requested is longer, while the time value is higher when the elapsed time is shorter. Thus, a price of the pay contents at this time is set on the ground that, for example, contents with a lower time value is cheaper than contents with a higher time value, so that the contents time information of each contents is reflected on the price information provided to the user.

As described above, according to the fifth embodiment, the contents time information indicating time value of each contents which is previously stored in the built-in recording medium 20 of the recording/reproduction device 10 is stored in the contents attribute information 23b in the built-in recording medium 20 of the recording/reproduction device 10, thereby reflecting the time value of pay contents on its price with reference to the contents time information, when providing the contents stored in the built-in recording medium 20 to a user.

While in the fifth embodiment a recording medium on which the contents are previously stored is the built-in recording medium 20 provided in the recording/reproduction device 10, the recording medium needs not be built inside but may be attached externally.

(Embodiment 6)

Hereinafter, a sixth embodiment of the present invention will be described with reference to FIGS. 14 to 16.

Initially, a description will be given of a state of a built-in recording medium 20 in a recording/reproduction device 10 at shipment according to the sixth embodiment, with reference to FIG. 14. FIG. 14 is a diagram illustrating the state of the built-in recording medium at the shipment of the recording/reproduction device according to the sixth embodiment.

With reference to FIG. 14, a contents storage area 23 according to the sixth embodiment previously contains system setup data 23d for each use area, which is required when a system of a recording/reproduction device 10 is set up, and use area information 23e indicating a use area corresponding to the system setup data 23d. The state of the built-in recording medium 20 of the recording/reproduction device 10 at shipment according to the sixth embodiment as for the rest is identical to that described for the second embodiment, and a user gets thee system setup data 23d stored in the built-in recording medium 20 when purchasing the recording/reproduction device 10.

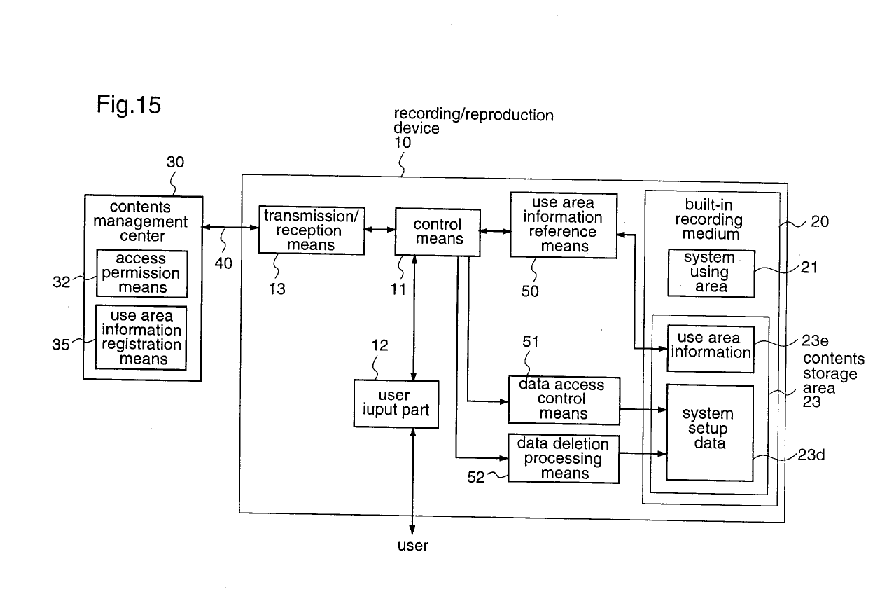

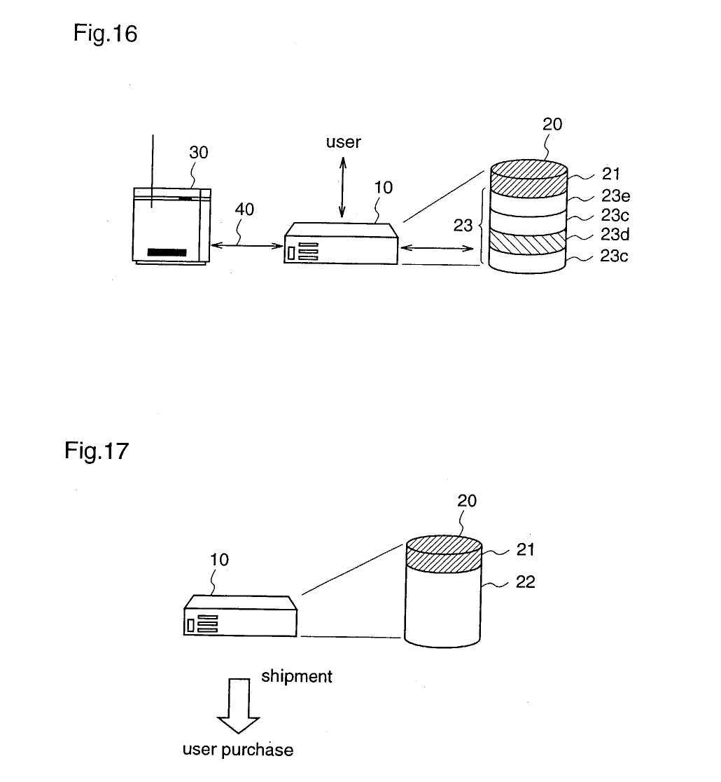

Next, a description will be given of the processing when the user sets up the recording/reproduction device 10 after purchasing the same, with reference to FIGS. 15 and 16. FIG. 15 is a diagram illustrating the construction of an information supply system according to the sixth embodiment, when the user sets up the recording/reproduction device after purchasing the same. FIG. 16 is a diagram illustrating the processing when the user sets up the recording/reproduction device after purchasing the same in the sixth embodiment.

Initially, the construction of the information supply system according to the sixth embodiment will be described with reference to FIG. 15.

With reference to FIG. 15, a contents management center 30 according to the fifth embodiment includes a use area registration means 35 for registering a use area where the recording/reproduction device 10 is used, which is inputted to the user input part 12, with both of the contents management center 30 and the use area information 23e on the built-in recording medium 20. Further, the recording/reproduction device 10 of the sixth embodiment includes a use area information reference means 50 for referring to the use area information 23e in the built-in recording medium 20, a data access control means 51 for accessing system setup data for the use area inputted by a user, and a data deletion processing means 52 for processing an area occupied by system setup data other than the system setup data that corresponds to the area registered by the use area information registration means 35, as a user available area 23c where no data exists. Other constituents are identical to those of the second embodiment, and descriptions thereof will be omitted here.

Next, a description will be given of the processing operation of the information supply system according to the sixth embodiment until the system of the recording/reproduction device 10 is set up, with reference to FIGS. 15 and 16.

Initially, when a user inputs an area where the recording/reproduction device 10 is used to the recording/reproduction device 10 through the user input part 12, the recording/reproduction device 10 reads the use area information 23e in the built-in recording medium 20 by the use area information reference means 50, and confirms whether the system setup data 23d corresponding to the use area inputted by the user is stored in the built-in recording medium 20 or not.

When there is the system setup data that corresponds to the use area inputted by the user, in the built-in recording medium 20, the recording/reproduction device 10 is connected with the contents management center 30 by the transmission/reception means 13 via the communication line 40, and the use area information registration means 35 registers the use area inputted by the user with both of the contents management center 30 and the use area information 23e in the built-in recording medium 20. At this point of time, the access permission means 32 of the contents management center 30 permits supply of the system setup data corresponding to the registered use area, and the system setup data is given to the user by the data access control means 51. Then, the data deletion processing means 52 processes an area occupied by system setup data other than the system setup data provided to the user at this time, which are previously stored in the contents storage area 23, as the user available area 23c where no data exists, so that new contents are recorded therein.

As described above, according to the sixth embodiment, the built-in recording medium 20 in the recording/reproduction device 10 previously contains the system setup data 23d for each use area and use area information 23e indicating a use area corresponding to the system setup data. Therefore, it is possible to provide a system which requires no new contents for system setup when setting up the recording/reproduction device 10, and is able to end setting up the recording/reproduction device 10 correspondingly to its use area, in a short time, without requiring a user who has purchased the recording/reproduction device 10 to perform complicated setting or the like.

Further, since the system setup data is provided after the use area of the recording/reproduction device 10 is registered by the use area information registration means 35, the contents management center 30 can recognize the area where the recording/reproduction device 10 is used by a user. Further, when the system setup data is provided after the use area information registration means 35 registers user's personal information or the like, in addition to the use area of the recording/reproduction device 10, information of the user who uses the recording/reproduction device 10 can be also obtained.

### Applicability in Industry

An information supply method, an information supply system, a recording/reproduction device, and a recording medium according to the present invention are extremely available to obtain more opportunities of contents distribution by increasing the activity ratio of a recording medium at shipment in an information supply system which enables a user to use contents stored in a recording medium, from/on which the contents can be read and rewritten via a recording/reproduction device.

1. An information supply method for storing contents in a recording medium from/on which the contents can be read and rewritten via a recording/reproduction device, and supplying a user with the stored contents, comprising:
using a user available area as a free space other than a system using area where data required for starting a system of the recording/reproduction device are stored, in a recording medium of the recording/reproduction device, as a contents storage area, and
shipping the recording/reproduction device in which the contents that can be used by the user are previously recorded in the contents storage area and supplying the same to the user, to supply the user with the contents.

2. An information supply system for storing contents in a recording medium from/on which the contents can be read and rewritten via a recording/reproduction device, and supplying a user with the stored contents, wherein
the recording/reproduction device has the recording medium which includes a system using area for storing data required to start a system of the recording/reproduction device, and a contents storage area in which the contents that can be used by the user are previously recorded, which is a user available area as a free space other than the system using area, and
the recording/reproduction device is shipped and supplied to the user.

3. A recording medium of a recording/reproduction device in an information supply method for storing contents in a recording medium from/on which the contents can be read and rewritten via a recording/reproduction device, and supplying a user with the stored contents, comprising:
a system using area containing data required to start a system of the recording/reproduction device, and a contents storage area containing the contents which can be used by the user, when the recording medium of the recording/reproduction device is shipped.

4. The information supply method as defined in claim 1, wherein
the contents are supplied to the user under control of a contents management center which is connected with the recording/reproduction device via a communication line,
the contents which can be used by the user, and contents attribute information indicating whether the contents are charged or free are previously recorded in the contents storage area of the recording medium, and
in the recording/reproduction device,
every time the user requests an access to contents stored in the contents storage area, the contents attribute information of the contents is referred to;
a condition of the access to the contents is set according to control information from the contents management center on the basis of the contents attribute information of the access-requested contents; and
when the access-requested contents are registered as being charged, the access condition is set so that the access-requested contents are to be purchased, pay contents purchase information of the access-requested pay contents is registered with the contents management center and the contents attribute information in the contents storage area after purchase of the access-requested pay contents is decided, and the access-requested pay contents are supplied to the user; and
when the access-requested contents are registered as being free, the access condition is set as “no-condition” and the access-requested free contents are supplied to the user.

5. The information supply system as defined in claim 2, which comprises the recording/reproduction device that is supplied to the user with the contents that can be used by the user and contents attribute information indicating whether the contents are charged or free, previously recorded in the contents storage area of the recording medium, and a contents management center which is connected with the recording/reproduction device via a communication line and manages the contents stored in the contents storage area of the recording medium, wherein
the recording/reproduction device includes:
a contents attribute information reference means for referring to the contents attribute information every time the user requests an access to the contents stored in the contents storage area; and
an access condition setting means for setting a condition of access to the contents which is requested to be accessed by the user according to control information from the contents management center on the basis of the result of the contents attribute information reference means, and
the contents management center comprises:
a contents purchase information registration means for registering pay contents purchase information of the access-requested pay contents with the contents management center and the contents attribute information in the contents storage area, when the access-requested contents are registered as being charged; and
an access permission means for permitting the user to access the access-requested pay contents on the basis of the pay contents purchase information.

6. The recording medium as defined claim 3, wherein
the contents which can be used by the user, and contents attribute information indicating whether the contents are charged or free are previously recorded in the contents storage area.

7. The recording/reproduction device connected to the contents management center in the information supply system as defined in claim 5, comprising:
a contents attribute information reference means for referring to the contents attribute information indicating whether the contents stored in the recording medium are charged or free, every time the user requests an access to the contents stored in the recording medium of the recording/reproduction device;
an access condition setting means for setting a condition of access to the contents which is requested to be accessed, on the basis of the result of the contents attribute information reference means;
a contents access control means for controlling user access to the contents on the basis of the access condition;
a transmission/reception means which is connected to the contents management center via the communication line to transmit/receive data and the control information; and
a control means for controlling the operation of the recording/reproduction device according to the control information from the contents management center.

8. The information supply method as defined in claim 4, wherein
in a case where the access-requested contents are registered as being charged, the access condition is set so that the access-requested pay contents are to be purchased,
when the user makes a purchase contents selection request to the contents management center, a list of pay contents and price information thereof, which are previously stored in the contents storage area are transmitted from the contents management center,
when the user selects contents to purchase from the list of pay contents, pay contents purchase information of the pay contents decided to be purchased is registered with the contents management center and the contents attribute information in the contents storage area after purchase of the pay contents is decided, and the pay contents are supplied to the user,
when the user specifies whether unpurchased contents other than the contents which is decided to be purchased are deleted from the contents storage area or not, information of the contents specified to be deleted is registered with the contents management center and the contents attribute information in the contents storage area as contents deletion information, and
an area occupied by the unpurchased contents specified to be deleted is processed as a user available area where no contents exists, on the basis of the contents deletion information.

9. The information supply system as defined in claim 5, wherein
the contents management center comprises:
a purchase contents selection means for selecting pay contents to be purchased from a list of pay contents which is transmitted from the contents management center, when the access-requested contents are registered as being charged;
a contents deletion specification means for specifying whether unpurchased contents other than the pay contents which is decided to be purchased by the purchase contents selection means are deleted or not; and
a contents deletion information registration means for registering deletion information of the contents which is specified by the contents deletion specification means with the contents management center and the contents attribute information in the contents storage area, and
the recording/reproduction device includes:
a contents deletion processing means for processing an area occupied by the contents registered by the contents deletion information registration means as a user available area where no contents exists.

10. The recording/reproduction device as defined in claim 7, comprising:
a purchase contents selection means for selecting contents to be purchased from a list of pay contents previously stored in the recording medium, which is transmitted from the contents management center;
a contents deletion specification means for specifying whether unpurchased contents other than the pay contents which is decided to be purchased by the purchase contents selection means are deleted or not; and
a contents deletion processing means for processing an area of the unpurchased contents that are specified by the contents deletion specification means as a user available area where no contents exists.

11. The information supply method as defined in claim 4, wherein
in a case where the access-requested contents are registered as being charged, the access condition is set so that the access-requested pay contents are to be purchased in a certain purchase mode,
when the user makes a purchase contents selection request to the contents management center, a list of pay contents, a contents purchase mode, and price information corresponding to the purchase mode, which are previously stored in the contents storage area are transmitted from the contents management center,
when the user selects contents to purchase from the list of pay contents, as well as specifies a purchase mode of the selected contents from the contents purchase mode, pay contents purchase information of the pay contents decided to be purchased, and the purchase mode thereof are registered with the contents management center and the contents attribute information in the contents storage area, and
after the registration, the pay contents are supplied to the user on the basis of the purchase mode.

12. The information supply system as defined in claim 5, wherein
the contents management center comprises:
a purchase contents selection means for selecting pay contents to be purchased from a list of pay contents which is transmitted from the contents management center, when the user requests an access to the pay contents in the contents storage area;
a purchase mode specification means for specifying a purchase mode of the pay contents to be purchased from contents purchase mode information which is transmitted from the contents management center in concurrence with the list of pay contents; and
a purchase mode information registration means for registering the purchase mode of the pay contents which is specified by the purchase mode specification means with the contents management center and the contents attribute information in the contents storage area, and
the recording/reproduction device includes:
an access control storage means for storing a state of a user access to the pay contents in order to control the same on the basis of the purchase mode of the pay contents registered by the purchase mode information registration means.

13. The recording/reproduction device as defined in claim 7, wherein
the access condition setting means sets a condition of an access to the contents to be purchased on the basis of a purchase mode of the pay contents to be purchased, which is registered with the contents attribute information and specified by the user, and
an access control storage means is provided to store a state of a user access to the contents in order to control the same according to the access condition.

14. The information supply method as defined in claim 4, wherein
the contents which can be used by the user, and the contents attribute information including the information indicating whether the contents are charged or free, and contents time information indicating a time value of the contents are previously recorded in the contents storage area of the recording medium,
in a case where the access-requested pay contents are registered as being charged, the access condition is set so that the access-requested pay contents are to be purchased,
when the user makes a purchase contents selection request to the contents management center, a list of pay contents and price information corresponding to the contents time information, which are previously stored in the contents storage area are transmitted from the contents management center,
when the user selects contents to purchase from the list of pay contents, the pay contents purchase information of the pay contents decided to be purchased is registered with the contents management center and the contents attribute information in the contents storage area, and then the pay contents are supplied to the user, while
in a case where the access-requested contents are registered as being free, the access condition is set according to the contents time information, and the free contents are supplied to the user on the basis of the access condition, and
free contents which have no time value according to the contents time information are not provided to the user, and an area thereof is processed as a user available area where no contents exists.

15. The information supply system as defined in claim 5, wherein
the contents which can be used by the user and the contents attribute information including the information indicating whether the contents are charged or free, and contents time information indicating a time value of the contents are previously recorded in the contents storage area, and
the recording/reproduction device includes:
a purchase contents selection means for selecting pay contents to be purchased from a list of pay contents and price information corresponding to the contents time information, which are transmitted from the contents management center, when the access-requested contents are registered as being charged; and
a contents management means for processing an area occupied by contents having no time value according to the contents time information, as a user available area where no contents exists, when the accessed contents are registered as being free.

16. The recording medium as defined in claim 3, wherein
the contents which can be used by the user, and contents attribute information including information indicating whether the contents are charged or free, and contents time information indicating time values of the contents are previously recorded in the contents storage area.

17. The recording/reproduction device as defined in claim 7 including:
a contents management means for processing an area occupied by free contents on the recording medium that has no time value according to contents time information indicating time values of the contents which is previously stored in the contents storage area, as a user available area where no contents exists.

18. The information supply method as defined in claim 1, wherein
the contents are supplied to the user according to control of a contents management center which is connected with the recording/reproduction device via a communication line,
system setup data for each use area, which is required to set up the recording/reproduction device, and use area information indicating a use area corresponding to the system setup data are previously stored in the contents storage area, and
in the recording/reproduction device,
it is checked whether the system setup data corresponding to a use area inputted by the user is stored in the contents storage area or not, with reference to the use area information,
when the system setup data corresponding to the use area is stored in the contents storage area, the use area is registered with the contents management center and the use area information in the contents storage area, and the system setup data corresponding to the use area is supplied to the user, and
an area occupied by system setup data other than the provided system setup data, which are previously stored in the contents storage area is processed as a user available area where no contents exists.

19. The information supply system as defined in claim 2 comprising: the recording/reproduction device which is supplied to the user with system setup data for each use area, which is required to set up the recording/reproduction device, and use area information indicating a use area corresponding to the system setup data, being previously recorded in the contents storage area of the recording medium; and a contents management center which is connected to the recording/reproduction device via a communication line and manages the system setup data recorded in the contents storage area, wherein
the recording/reproduction device includes:
a use area information reference means for referring to the use area information indicating the use area corresponding to the setup data, which is stored in the contents storage area;
a data access control means for providing the user with the system setup data corresponding to the use area from the contents storage area, so that the provided system setup data is used for setup; and
a data deletion processing means for processing an area occupied by system setup data other than the system setup data provided by the data access control means, which are previously stored in the contents storage area, as a user available area where no data exists, and
the contents management center comprises:
a use area information registration means for registering the use area inputted by the user with the contents management center and the use area information in the contents storage area; and
an access permission means for permitting the user to access the system setup data corresponding to the use area on the basis of the use area information registration means.

20. The recording medium as defined in claim 3, wherein
system setup data for each use area, which is required to set up the recording/reproduction device, and use area information indicating a use area corresponding to the system setup data are previously recorded in the contents storage area.

21. The recording/reproduction device connected to the contents management center in the information supply system as defined in claim 19, wherein
the recording/reproduction device includes:
the use area information reference means for referring to the use area information stored in the recording medium when the user inputs a use area where the recording/reproduction device is used, at setup;
the data access control means for providing the user with the system setup data corresponding to the inputted use area, so that the provided system setup data is used for setup; and
the data deletion processing means for processing the area occupied by the system setup data other than the system setup data provided by the data access control means, which are previously stored in the contents storage area, as the user available area where no data exists.
